(19) United States
(12) Patent Application Publication
(10) Pub. No.: US 2015/0284934 A1
(43) Pub. Date: Oct. 8, 2015

(54) APPARATUS AND METHOD FOR CONTROLLING SWING OF CONSTRUCTION MACHINE

(71) Applicant: VOLVO CONSTRUCTION EQUIPMENT AB, Eskilstuna (SE)

(72) Inventor: Ok-Jin Suk, Changwon-si (KR)

(73) Assignee: VOLVO CONSTRUCTION EQUIPMENT AB, Eskilstuna (SE)

(21) Appl. No.: 14/440,015

(22) PCT Filed: Nov. 5, 2012
(86) PCT No.: PCT/KR2012/009218

§ 371 Date: Apr. 30, 2015

(51) Int. Cl. E02F 9/22; F15B 9/17; F15B 9/09

(52) U.S. Cl. CPC E02F 9/2228; F15B 9/09; F15B 9/17

(57) ABSTRACT

Disclosed are an apparatus and method for controlling the swing of a construction machine, which are capable of achieving a preferential boom-up function or a preferential swing function based on a swing angle during the loading work using a complex operation of a boom-up and swing. The method for controlling the swing of a construction machine, comprises: a first step of selecting a preferential boom-up function or a preferential swing function via an external input device; a second step of determining whether to operate a complex operation by an operation signal based on the operation of a boom joystick and a swing joystick; and a third step of variably controlling, if the preferential boom-up function is selected and if it is a complex operation condition, the degree of opening of an electro hydraulic valve for the swing so as to relatively limit the flow that is supplied from a hydraulic pump to a swing motor, and variably controlling, if the preferential swing function is selected and if it is a complex operation condition, the degree of opening of an electro hydraulic valve for the boom so as to relatively limit the flow that is supplied from the hydraulic pump to a boom cylinder.

### TECHNICAL FIELD

The present invention relates to a swing control apparatus and method for a construction machine. More particularly, the present invention relates to such a swing control apparatus and method, in which a boom-up priority function or a swing priority function can be implemented depending on the swing angle during the loading work using a combined operation of boom-up and swing of an excavator.

### BACKGROUND OF THE INVENTION

In general, the loading work using an excavator is divided into a digging work for digging or loading earth and sand, a dumping work for loading a dump truck with the dug earth and sand, and a return work for returning to a work spot re-dig the earth and sand.

The dumping work is carried out such that after the digging work for digging the ground is completed, a swing joystick and a boom joystick are simultaneously manipulate by a user to control the swing angle and the boom-up height of an upper swing structure so that the excavated material can be swingably moved to a dumping location.

As shown in FIG. 1, a swing control apparatus for a construction machine in accordance with the prior art includes:

a hydraulic pump 1 connected to an engine;

a swing motor 2 and a boom cylinder 3, which are connected in parallel to the hydraulic pump 1;

a swing control valve 4 installed in a flow path between the hydraulic pump 1 and the swing motor 2 and configured to be shifted to control a start, a stop and a direction change of the swing motor 2;
a boom control valve 5 installed in a flow path between the hydraulic pump 1 and the boom cylinder 3 and configured to be shifted to control a start, a stop and a direction change of the boom cylinder 3;

a swing joystick 6 configured to output a control signal to shift a spool of the swing control valve 4; and

a boom joystick 7 configured to output a control signal to shift a spool of the boom control valve 5.

As shown in FIG. 1, when an operator manipulates the swing joystick 6 and the boom joystick 7 to perform a combined operation of boom-up and swing for the purpose of the loading work, the spool of the swing control valve 4 is shifted to the right on the drawing sheet depending on the manipulation amount of the swing joystick 6, and the spool of the boom control valve 5 is shifted to the left on the drawing sheet depending on the manipulation amount of the boom joystick 7.

Thus, a part of the hydraulic fluid discharged from the hydraulic pump 1 is supplied to the swing motor 2 via the swing control valve 4, of which the spool is shifted so that the upper swing structure (not shown) can be swiveled. A part of the hydraulic fluid discharged from the hydraulic pump 1 is supplied to a large chamber of the boom cylinder 3 via the boom control valve 5, of which the spool is shifted so that a boom-up operation can be performed. As a result, earth and sand or the like can be excavated and loaded onto the dump truck by performing a combined operation of boom-up and swing.

The swing motor 2 generates a load pressure caused by the swing of the upper swing structure, and the boom cylinder 2 generates a load pressure caused by a load of the dumped material and a load pressure caused by the operation of an attachment such as a boom. The swing motor 2 generates a load that is relatively higher than that of the boom cylinder 3.

In this case, the flow rate of hydraulic fluid supplied from hydraulic pump 1 is increased in the boom cylinder 3 having a load pressure lower than that of the swing motor 2 in terms of the hydraulic characteristics of a hydraulic system. The hydraulic system having this boom-up priority function can easily perform the loading work when the boom driving speed is higher than the swing speed of the upper swing structure during the dumping work as a condition required by an operator during the dumping work.

In other words, a fixed orifice 4a is formed in the spool of the swing control valve 4 to increase the flow rate of hydraulic fluid supplied to the boom cylinder 2 so that the boom-up driving speed can be enhanced. In this case, if the flow rate of hydraulic fluid supplied to the swing motor 2 is relatively reduced by the fixed orifice 4a formed in the swing control valve 4, there is caused a problem in that a power loss occurs, thus leading to a degradation of the fuel efficiency.

In addition, in the case where only a swing operation but not the combined operation of boom-up and swing is performed, the supply of the hydraulic fluid to the swing motor 2 is restricted by the fixed orifice 4a, thus resulting in a continuous loss of power. Further, if the dumping work is carried out at a work section at which the swing angle is relatively large, the loading work time is further increased due to a boom-up priority function, thereby deteriorating workability.

Meanwhile, even in the case where earth and sand is excavated to perform the loading work and then the upper swing structured is swiveled to be positioned at a loading place to dump the excavated material onto the dump truck at a work section at which the swing angle is relatively small, the boom may be not lifted sufficiently up to the loading height.

In the case where the loading work is performed, as the swing angle is small, the workability is improved during the dumping and returning operation, and the work time can be reduced and thus the dumping operation for a zero tail type excavator can be implemented, thereby improving the fuel efficiency.

### SUMMARY OF THE INVENTION

Accordingly, the present invention has been made to solve the aforementioned problems occurring in the prior art, and it is an object of the present invention to provide a swing control apparatus and method for a construction machine, in which a boom-up priority function is implemented at the work range at which the swing angle is relatively small, and a swing priority function is implemented at the work range at which the swing angle is relatively large during the loading work to improve workability and manipulability.

### TECHNICAL SOLUTION

To achieve the above object, in accordance with an embodiment of the present invention, there is provided a swing control method for a construction machine including a hydraulic pump, a swing motor and a boom cylinder connected in parallel to the hydraulic pump, a swing electro-hydraulic valve installed in a flow path between the hydraulic pump and the swing motor, a boom electro-hydraulic valve installed in a flow path between the hydraulic pump and the boom cylinder, a swing joystick and a boom joystick, and a controller, the swing control method including:

a first step of selecting a boom-up priority function or a swing priority function through an external input device;

a second step of determining whether to perform a combined operation of boom-up and swing based on a manipulation signal applied to the controller in response to a manipulation of the boom joystick and the swing joystick; and

a third step of relatively limiting the flow rate of hydraulic fluid supplied from the hydraulic pump to the swing motor by variably controlling the amount of opening of the swing electro-hydraulic valve if a boom-up priority function is selected and the combined operation is set to be performed, and relatively limiting the flow rate of hydraulic fluid supplied from the hydraulic pump to the boom cylinder by variably controlling the amount of opening of the boom electro-hydraulic valve if a swing priority function is selected and the combined operation is set to be performed.

The external input device in the first step may include a work range select switch which outputs a manipulation signal according to the manipulation of the swing joystick or the boom joystick to the controller so that the controller can control the amount of opening of the boom or swing electro-hydraulic valve to correspond to a swing angle selected by a user after a work range by the swing angle is preset and stored in the controller by the user.

If a first switch unit of the work range select switch is selected, the controller may recognize the work range as a work range at which the swing angle is relatively small and control the amount of opening of the boom or swing electro-hydraulic valve to correspond to the relatively small swing angle preset and stored in the controller.

If a second switch unit of the work range select switch is selected, the controller may recognize the work range as a work range at which the swing angle is relatively intermediate and control the amount of opening of the boom or swing electro-hydraulic valve to correspond to the relatively intermediate swing angle preset and stored in the controller.

In addition, if a third switch unit of the work range select switch is selected, the controller may recognize the work range as a work range at which the swing angle is relatively large and controls the amount of opening of the boom or swing electro-hydraulic valve to correspond to the relatively large swing angle preset and stored in the controller.

The swing electro-hydraulic valve and the boom electro-hydraulic valve may include first and second variable orifices installed in meter-in paths and third and fourth variable orifices installed in meter-out paths, respectively, so as to variably control the amount of opening of the swing electro-hydraulic valve and the boom electro-hydraulic valve in proportion to the control signal applied thereto from the controller.

The external input device in the first step (S100) may include an on/off select switch for allowing a user to select the boom-up priority function or the swing priority function.

If a boom-up priority function select switch is operated to be turned on and a swing priority function select switch is operated to be turned off, the boom-up priority function may be determined to be selected.

On the other hand, if a swing priority function select switch is operated to be turned on and the boom-up priority function select switch is operated to be turned off, the swing priority function may be determined to be selected.

If the boom-up priority function select switch and the swing priority function select switch are operated to be turned off, the amounts of opening of the boom electro-hydraulic valve 14 and the swing electro-hydraulic valve 13 may be controlled in proportion to the manipulation signals by the manipulation of the boom joystick 16 and the swing joystick 15.

If a signal indicating the combined operation by the manipulations of the boom joystick 16 and the swing joystick 15 is not applied to the controller 17, the amounts of opening of the boom electro-hydraulic valve 14 and the swing electro-hydraulic valve 13 may be controlled in proportion to the manipulation signal by the manipulation of the boom joystick 16 or the swing joystick 15.

The external input device in the first step (S100) may include an imaging means for capturing an image of a work range by the swing angle at a work spot and transmitting an image signal indicating the captured image to the controller 17.

If the work range by the swing angle, of which the image is captured by the imaging means, is larger than a work range by the swing angle, which is pre-stored in the controller 17, the swing priority function may be determined to be selected.

On the other hand, if the work range by the swing angle, of which the image is captured by the imaging means, is smaller than the work range by the swing angle, which is pre-stored in the controller 17, the boom-up priority function may be determined to be selected.

In accordance with another preferred embodiment of the present invention, there is provided a swing control apparatus for a construction machine, including:

a hydraulic pump connected to an engine (not shown);

a swing motor and a boom cylinder, which are connected in parallel to the hydraulic pump;

a swing electro-hydraulic valve which is installed in a flow path between the hydraulic pump and the swing motor and of which the amount of opening is variably controlled by a control signal applied thereto from an outside;

a boom electro-hydraulic valve which is installed in a flow path between the hydraulic pump and the boom cylinder and of which the amount of opening is variably controlled by a control signal applied thereto from the outside;

a swing joystick configured to output a manipulation signal for controlling the swing motor;

a boom joystick configured to output a manipulation signal for controlling the boom cylinder;

an external input device configured to select a boom-up priority function or a swing priority function; and a controller configured to relatively limit the flow rate of hydraulic fluid supplied from the hydraulic pump to the swing motor by variably controlling the amount of opening of the swing electro-hydraulic valve if the boom-up priority function is selected by a manipulation of the external input device and a combined operation of boom-up and swing is set to be performed by the manipulations of the swing joystick and the boom joystick, and relatively limit the flow rate of hydraulic fluid supplied from the hydraulic pump to the boom cylinder by variably controlling the amount of opening of the boom electro-hydraulic valve if the swing priority function is selected by a manipulation of the external input device and the combined operation is set to be performed by the manipulations of the swing joystick and the boom joystick.

The external input device may include an imaging device for capturing an image of a work range by the swing angle at a work spot and transmitting an image signal indicating the captured image to the controller 17.

If the work range by the swing angle, of which the image is captured by the imaging device, is larger than a work range by the swing angle, which is pre-stored in the controller 17, the swing priority function may be determined to be selected.

On the other hand, if the work range by the swing angle, of which the image is captured by the imaging device, is smaller than the work range by the swing angle, which is pre-stored in the controller 17, the boom-up priority function may be determined to be selected.

### Advantageous Effect

The swing control apparatus and method for a construction machine in accordance with an embodiment of the present invention as constructed above has the following advantages.

The boom-up priority function is implemented at the work range at which the swing angle is relatively small, and the swing priority function is implemented at the work range at which the swing angle is relatively large during the loading work to improve workability and manipulability.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a hydraulic circuit diagram of a swing control apparatus for a construction machine in accordance with the prior art;

FIG. 2 is a hydraulic circuit diagram of a swing control apparatus for a construction machine in accordance with a preferred embodiment of the present invention; and

FIG. 3 is a flow chart showing a swing control method for a construction machine in accordance with another preferred embodiment of the present invention.

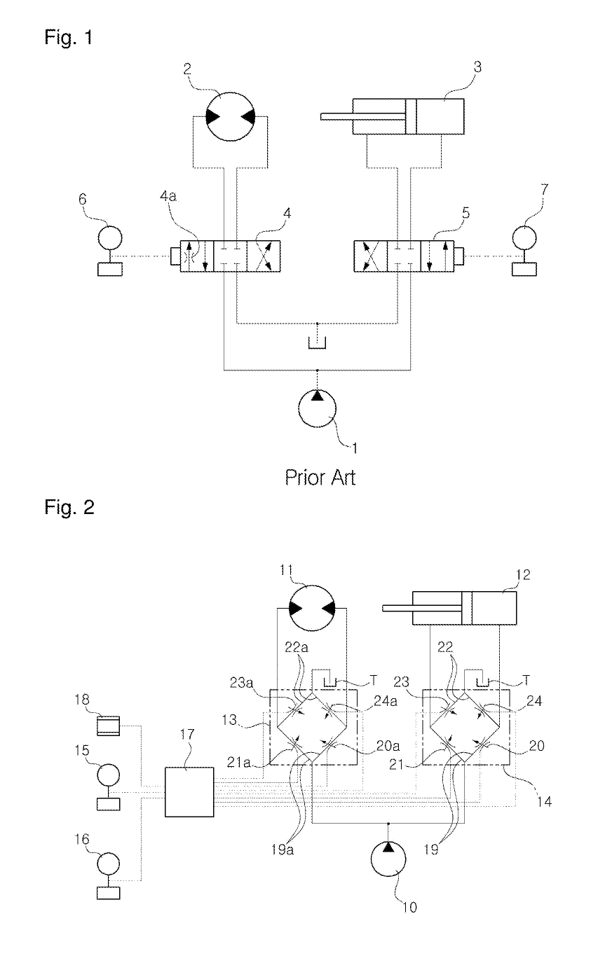

### EXPLANATION ON REFERENCE NUMERALS OF MAIN ELEMENTS IN THE DRAWINGS

10: hydraulic pump
11: swing motor
12: boom cylinder
13: swing electro-hydraulic valve
14: boom electro-hydraulic valve
15: swing joystick
16: boom joystick
17: controller (ECU)
18: work range select switch
19: meter-in path
20,20a: first variable orifice
21,21a: second variable orifice
22: meter-out path
23,23a: third variable orifice
24,24a: fourth variable orifice

### DETAILED DESCRIPTION OF THE INVENTION

Now, a swing control apparatus for construction machine in accordance with preferred embodiments of the present invention will be described in detail with reference to the accompanying drawings. The matters defined in the description, such as the detailed construction and elements, are nothing but specific details provided to assist those of ordinary skill in the art in a comprehensive understanding of the invention, and the present invention is not limited to the embodiments disclosed hereinafter.

Hereinafter, a swing control method for a construction machine in accordance with a preferred embodiment of the present invention will be described in detail with reference with the accompanying drawings.

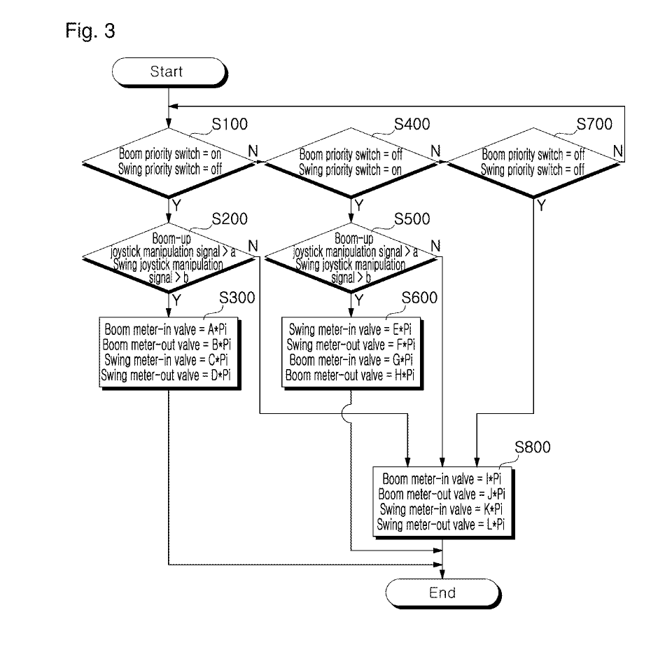

FIG. 2 is a hydraulic circuit diagram of a swing control apparatus for a construction machine in accordance with a preferred embodiment of the present invention, and FIG. 3 is a flow chart illustrating a swing control method for a construction machine in accordance with another preferred embodiment of the present invention.

Referring to FIGS. 2 and 3, in accordance with a preferred embodiment of the present invention, in a construction machine including a hydraulic pump 10 connected to an engine (not shown), a swing motor 11 and a boom cylinder 12 connected in parallel to the hydraulic pump 10, a swing electro-hydraulic valve 13 installed in a flow path between the hydraulic pump 10 and the swing motor 11, a boom electro hydraulic valve 14 installed in a flow path between the hydraulic pump 10 and the boom cylinder 12, a swing joystick 15 and a boom joystick 16, and a controller 17, a swing control method for the construction machine includes:

a first step (S100) of selecting a boom-up priority function or a swing priority function through an external input device by a user;

a second step (S200) of determining whether to perform a combined operation of boom-up and swing for the loading work based on a manipulation signal applied to the controller 17 in response to a manipulation of the boom joystick 16 and the swing joystick 15; and

a third step (S300) of relatively limiting the flow rate of hydraulic fluid supplied from the hydraulic pump 10 to the swing motor 11 by variably controlling the amount of opening of the swing electro-hydraulic valve 13 if a boom-up priority function is selected and the combined operation is set to be performed, and relatively limiting the flow rate of hydraulic fluid supplied from the hydraulic pump 10 to the boom cylinder 12 by variably controlling the amount of opening of the boom electro-hydraulic valve 14 if a swing priority function is selected and the combined operation is set to be performed.

The external input device in the first step (S100) includes a work range select switch 18 (e.g., a rotary switch) which outputs a manipulation signal according to the manipulation of the swing joystick or the boom joystick to the controller 17 so that the controller 17 can control the amount of opening of the boom or swing electro-hydraulic valve 13 or 14 to correspond to a swing angle selected by a user after a work range by the swing angle is preset and stored in the controller 17 by the user.

If a first switch unit of the work range select switch 18 is selected, the controller 17 recognizes the work range as a work range at which the swing angle is relatively small and controls the amount of opening of the boom or swing electro-hydraulic valve 13 or 14 to correspond to the relatively small swing angle preset and stored in the controller 17.

If a second switch unit of the work range select switch 18 is selected, the controller 17 recognizes the work range as a work range at which the swing angle is relatively intermediate and controls the amount of opening of the boom or swing electro-hydraulic valve 13 or 14 to correspond to the relatively intermediate swing angle preset and stored in the controller 17.

In addition, if a third switch unit of the work range select switch 18 is selected, the controller 17 recognizes the work range as a work range at which the swing angle is relatively large and controls the amount of opening of the boom or swing electro-hydraulic valve 13 or 14 to correspond to the relatively large swing angle preset and stored in the controller 17.

The swing electro-hydraulic valve and the boom electro-hydraulic valve may include first and second variable orifices installed in meter-in paths and third and fourth variable orifices installed in meter-out paths, respectively, so as to variably control the amount of opening of the swing electro-hydraulic valve and the boom electro-hydraulic valve in proportion to the control signal applied thereto from the controller.

The external input device in the first step (S100) includes an on/off select switch (not shown) for allowing a user to select the boom-up priority function or the swing priority function,

If a boom-up priority function select switch is operated to be turned on and a swing priority function select switch is operated to be turned off, the boom-up priority function is determined to be selected.

If a boom-up priority function select switch is operated to be turned on, a swing priority function select switch is operated to be turned off, and the manipulation signal is applied to the controller 17 in response to the manipulation of the boom joystick 16 and the swing joystick 15 to perform the combined operation, the boom-up priority function is determined to be selected.

On the other hand, if a swing priority function select switch is operated to be turned on and the boom-up priority function select switch is operated to be turned off, and the manipulation signal is applied to the controller 17 in response to the manipulation of the boom joystick 16 and the swing joystick 15 to perform the combined operation, the swing priority function is determined to be selected.

If the boom-up priority function select switch and the swing priority function select switch are operated to be turned off, the amounts of opening of the boom electro-hydraulic valve 14 and the swing electro-hydraulic valve 13 are controlled in proportion to the manipulation signals by the manipulation of the boom joystick 16 or the swing joystick 15.

If a signal indicating the combined operation by the manipulations of the boom joystick 16 and the swing joystick 15 is not applied to the controller 17, the amounts of opening of the boom electro-hydraulic valve 14 and the swing electro-hydraulic valve 13 are controlled in proportion to the manipulation signal by the manipulation of the boom joystick 16 and the swing joystick 15.

Although not shown in the accompanying drawings, the external input device in the first step (S100) includes an imaging means (not shown) for capturing an image of a work range by the swing angle at a work spot and transmitting an image signal indicating the captured image to the controller 17.

If the work range by the swing angle, of which the image is captured by the imaging means, is larger than a work range by the swing angle, which is pre-stored in the controller 17, the swing priority function is determined to be selected.

On the other hand, if the work range by the swing angle, of which the image is captured by the imaging means, is smaller than the work range by the swing angle, which is pre-stored in the controller 17, the boom-up priority function is determined to be selected.

A swing control apparatus for a construction machine in accordance with another preferred embodiment of the present invention includes:

a hydraulic pump 10 connected to an engine (not shown);

a swing motor 11 and a boom cylinder 12, which are connected in parallel to the hydraulic pump 10;

a swing electro-hydraulic valve 13 which is installed in a flow path between the hydraulic pump 10 and the swing motor 11 and of which the amount of opening is variably controlled by a control signal applied thereto from an outside;

a boom electro-hydraulic valve 14 which is installed in a flow path between the hydraulic pump 10 and the boom cylinder 12 and of which the amount of opening is variably controlled by a control signal applied thereto from the outside;

a swing joystick 15 configured to output a manipulation signal for controlling the swing motor 11;

a boom joystick 16 configured to output a manipulation signal for controlling the boom cylinder 12;

an external input device (not shown) configured to select a boom-up priority function or a swing priority function; and

a controller 17 (ECU) configured to relatively limit the flow rate of hydraulic fluid supplied from the hydraulic pump 10 to the swing motor 11 by variably controlling the amount of opening of the swing electro-hydraulic valve 13 if the boom-up priority function is selected by a manipulation of the external input device and a combined operation of boom-up and swing is set to be performed by the manipulations of the swing joystick 15 and the boom joystick 16, and relatively limit the flow rate of hydraulic fluid supplied from the hydraulic pump 10 to the boom cylinder 12 by variably controlling the amount of opening of the boom electro-hydraulic valve 14 if the swing priority function is selected by a manipulation of the external input device and the combined operation is set to be performed by the manipulations of the swing joystick 15 and the boom joystick 16.

Although not shown in the accompanying drawings, the external input device includes an imaging device for capturing an image of a work range by the swing angle at a work spot and transmitting an image signal indicating the captured image to the controller 17.

If the work range by the swing angle, of which the image is captured by the imaging device, is larger than a work range by the swing angle, which is pre-stored in the controller 17, the swing priority function is determined to be selected.

On the other hand, if the work range by the swing angle, of which the image is captured by the imaging device, is smaller than the work range by the swing angle, which is pre-stored in the controller 17, the boom-up priority function is determined to be selected.

Hereinafter, a swing control method for a construction machine in accordance with another embodiment of the present invention will be described in detail with reference with accompanying drawings.

Now, the case will be described where when a user (or an operator of a construction machine) manipulates the boom joystick 16, the swing joystick 15, and the on/off select switch to perform the loading work, the boom-up priority function or the swing priority function is implemented.

At step S100, the controller 17 determines whether or not the boom-up priority function select switch and the swing priority function select switch is turned on or off. If it is determined at step S100 that the boom-up priority function select switch is operated to be turned on and the swing priority function select switch is operated to be turned off, the program proceeds to step S200.

At step S200, it is determined that a boom-up manipulation signal (Cmd) by the manipulation of the boom joystick 16 by the user is larger than a predetermined boom-up pressure a pre-stored in the controller 17 and a swing manipulation signal (Cmd) by the manipulation of the swing joystick 15 by the user is larger than a predetermined swing pressure b pre-stored in the controller 17, the controller 17 determines that the combined operation of boom-up and swing is set to be performed by the manipulations of the swing joystick 15 and the boom joystick 16, and the program proceeds to step S300.

At S300, in the case where the boom-up priority function is selected (S100) and the combined operation of boom-up and swing is performed (S200), the controller 17 variably controls the amount of opening of the swing electro-hydraulic valve 13. In other words, the controller 17 outputs a control signal for application to the boom electro-hydraulic valve 14 to variably control the amounts of opening of the first variable orifice 20 installed in the meter-in path 19 of the boom electro-hydraulic valve 14 and the third variable orifice 23 installed in the meter-out path 22 of the boom electro-hydraulic valve 14.

As a result, the hydraulic fluid discharged from the hydraulic pump 10 is supplied to a large chamber of the boom cylinder 12 via the first variable orifice 20 and the hydraulic fluid discharged from a small chamber of the boom cylinder 12 is fed back to a hydraulic tank T via the third variable orifice 23. Thus, the boom cylinder 12 can be driven in a stretchable manner to perform a boom-up operation.

In this case, a value of the amount of opening of the first variable orifice 20 is calculated by the following equation:

A×Pi

wherein A is a constant and Pi is a pilot signal pressure by the manipulation of the boom joystick 16.

In addition, a value of the amount of opening of the third variable orifice 23 is calculated by the following equation:

B×Pi

wherein B is a constant and Pi is a pilot signal pressure by the manipulation of the boom joystick 16.

Further, the controller 17 outputs a control signal for application to the swing electro-hydraulic valve 13 to variably control the amounts of opening of the second variable orifice 20a or 21a installed in the meter-in path 19a of the swing electro-hydraulic valve 13 and the fourth variable orifice 23a or 24a installed in the meter-out path 22a of the swing electro-hydraulic valve 13.

As a result, the hydraulic fluid discharged from the hydraulic pump 10 is supplied to the swing motor 11 via the second first variable orifice 20a or 21a and the hydraulic fluid discharged from the swing motor 11 is fed back to a hydraulic tank T via the fourth variable orifice 23a and 24a. Thus, the swing motor 11 can be driven to swivel an upper swing structure.

In this case, a value of the amount of opening of the second variable orifice 20a or 21a is calculated by the following equation:

C×Pi

wherein C is a constant and Pi is a pilot signal pressure by the manipulation of the swing joystick 15.

In addition, a value of the amount of opening of the fourth variable orifice 23a or 24a is calculated by the following equation:

D×Pi

wherein D is a constant and Pi is a pilot signal pressure by the manipulation of the swing joystick 15.

Thus, when the boom-up priority function select switch is operated to be turned on (S100) and the combined operation of boom-up and swing is performed by the manipulations of the boom joystick 16 and the swing joystick 15 (S200), the amount of opening of the swing electro-hydraulic valve 13 is variably controlled to relatively limit the flow rate of hydraulic fluid supplied from the hydraulic pump 10 to the swing motor 11 so that the boom-up priority function can be implemented.

At step S400, the controller 17 determines whether or not the boom-up priority function select switch and the swing priority function select switch is turned on or off. If it is determined at step 400 that the boom-up priority function select switch is operated to be turned off and the swing priority function select switch is operated to be turned on, the program proceeds to step S500.

At step S500, it is determined that a boom-up manipulation signal (Cmd) by the manipulation of the boom joystick 16 by the user is larger than a predetermined boom-up pressure a pre-stored in the controller 17 and a swing manipulation signal (Cmd) by the manipulation of the swing joystick 15 by the user is larger than a predetermined swing pressure b pre-stored in the controller 17, the controller 17 determines that the combined operation of boom-up and swing is set to be performed by the manipulations of the swing joystick 15 and the boom joystick 16, and the program proceeds to step S600.

At S600, in the case where the swing priority function is selected (S400) and the combined operation of boom-up and swing is performed (S500), the controller 17 variably controls the amount of opening of the boom electro-hydraulic valve 14. In other words, the controller 17 outputs a control signal for application to the swing electro-hydraulic valve 13 to variably control the amounts of opening of the second variable orifice 20a or 21a installed in the meter-in path 19a of the swing electro-hydraulic valve 13 and the fourth variable orifice 23a or 24a installed in the meter-out path 22a of the swing electro-hydraulic valve 13.

In this case, a value of the amount of opening of the second variable orifice 20a and 21a is calculated by the following equation:

E×Pi

wherein E is a constant and Pi is a pilot signal pressure by the manipulation of the swing joystick 15.

In addition, a value of the amount of opening of the fourth variable orifice 23a or 24a is calculated by the following equation:

F×Pi

wherein F is a constant and Pi is a pilot signal pressure by the manipulation of the swing joystick 15.

Further, the controller 17 outputs a control signal for application to the boom electro-hydraulic valve 14 to variably control the amounts of opening of the first variable orifice 20 installed in the meter-in path 19 of the boom electro-hydraulic valve 14 and the third variable orifice 23 installed in the meter-out path 22 of the boom electro-hydraulic valve 14.

In this case, a value of the amount of opening of the first variable orifice 20 is calculated by the following equation:

G×Pi

wherein G is a constant and Pi is a pilot signal pressure by the manipulation of the boom joystick 16.

In addition, a value of the amount of opening of the third variable orifice 23 is calculated by the following equation:

H×Pi

wherein H is a constant and Pi is a pilot signal pressure by the manipulation of the boom joystick 16.

Thus, when the swing priority function select switch is operated to be turned on (S400) and the combined operation of boom-up and swing is performed by the manipulations of the boom joystick 16 and the swing joystick 15 (S500), the amount of opening of the boom electro-hydraulic valve 14 is variably controlled to relatively limit the flow rate of hydraulic fluid supplied from the hydraulic pump 10 to the boom cylinder 12 so that the swing priority function can be implemented.

At step S700, the controller 17 determines whether or not the boom-up priority function select switch and the swing priority function select switch is turned on or off by the user. If it is determined at step 700 that the boom-up priority function select switch and the swing priority function select switch are operated to be turned off, the program proceeds to step S800. On the other hand, if it is determined at step S700 that the boom-up priority function select switch the swing priority function select switch are operated to be turned on, the program returns to S100.

At step S800, if the boom-up priority function and the swing priority function are not selected, the amounts of opening of the boom electro-hydraulic valve 14 and the swing electro-hydraulic valve 13 are controlled in proportion to the manipulation signal by the manipulation of the boom joystick 16 or the swing joystick 15.

In addition, if a signal indicating the combined operation by the manipulations of the boom joystick 16 and the swing joystick 15 is not applied to the controller 17, the controller 17 determines that the loading work is set not to be performed. Thus, the amounts of opening of the boom electro-hydraulic valve 14 and the swing electro-hydraulic valve 13 are controlled in proportion to the manipulation signal by the manipulation of the boom joystick 16 or the swing joystick 15.

In this case, the controller 17 outputs a control signal for application to the boom electro-hydraulic valve 14 to variably control the amounts of opening of the first variable orifice 20 installed in the meter-in path 19 of the boom electro-hydraulic valve 14 and the third variable orifice 23 installed in the meter-out path 22 of the boom electro-hydraulic valve 14.

In this case, a value of the amount of opening of the first variable orifice 20 is calculated by the following equation:

I×Pi

wherein I is a constant and Pi is a pilot signal pressure by the manipulation of the boom joystick 16.

In addition, a value of the amount of opening of the third variable orifice 23 is calculated by the following equation:

J×Pi

wherein J is a constant and Pi is a pilot signal pressure by the manipulation of the boom joystick 16.

Further, the controller 17 outputs a control signal for application to the swing electro-hydraulic valve 13 to variably control the amounts of opening of the second variable orifice 20a or 21a installed in the meter-in path 19a of the swing electro-hydraulic valve 13 and the fourth variable orifice 23a or 24a installed in the meter-out path 22a of the swing electro-hydraulic valve 13.

In this case, a value of the amount of opening of the second variable orifice 20a or 21a is calculated by the following equation:

K×Pi

wherein K is a constant and Pi is a pilot signal pressure by the manipulation of the swing joystick 15.

In addition, a value of the amount of opening of the fourth variable orifice 23a or 24a is calculated by the following equation:

L×Pi

wherein L is a constant and Pi is a pilot signal pressure by the manipulation of the swing joystick 15.

Meanwhile, the case will be described where when the user manipulates the boom joystick 16, the swing joystick 15, and the work range select switch to perform the loading work, the boom-up priority function or the swing priority function is implemented. In this case, a work range by the swing angle for the loading work is preset and stored in the controller 17 by the user.

The work range select switch 18 can employ an on/off function that can select the boom-up priority function or the swing priority function during the manipulation thereof, and a rotary switch that outputs a manipulation signal to the controller 17 so that the amount of opening of the boom or swing electro-hydraulic valve 13 or 14 can be controlled to correspond to the swing angle selected by the user. For example, the rotary switch can be converted into a first switch unit in which the swing angle is set to be relatively small, a second switch unit in which the swing angle is set to be relatively intermediate, and a third switch unit in which the swing angle is set to be relatively large.

When the boom-up priority function or the swing priority function is selected by the on/off manipulation of the work range select switch 18, a manipulation signal according to the selection of the first switch unit (not shown) of the work range select switch 18 is applied to the controller 17. Thus, the controller 17 recognizes the work range as a work range at which the swing angle is relatively small (e.g., the swing angle is 90° or less) so that the amount of opening of the boom or swing electro-hydraulic valve 13 or 14 can be controlled to correspond to the relatively small swing angle preset and stored in the controller 17.

In addition, when the second switch unit (not shown) of the work range select switch 18 is selected, a manipulation signal according to the selection of the second switch unit is applied to the controller 17. Thus, the controller 17 recognizes the work range as a work range at which the swing angle is relatively intermediate (e.g., the swing angle ranges from 90° to 120°) so that the amount of opening of the boom or swing electro-hydraulic valve 13 or 14 can be controlled to correspond to the relatively intermediate swing angle preset and stored in the controller 17.

Besides, when the third switch unit (not shown) of the work range select switch 18 is selected, a manipulation signal according to the selection of the third switch unit is applied to the controller 17. Thus, the controller 17 recognizes the work range as a work range at which the swing angle is relatively large (e.g., the swing angle ranges from 120° to 180°) so that the amount of opening of the boom or swing electro-hydraulic valve 13 or 14 can be controlled to correspond to the relatively large swing angle preset and stored in the controller 17.

In the meantime, in the case where an imaging device including a camera captures an image of a work range by the swing angle at a work spot and transmits an image signal indicating the captured image to the controller 17, the boom-up priority function or the swing priority function can be selected depending on the work range based on the image signal. Therefore, the loading work can be efficiently carried out using an unmanned automatic excavator which is expected to be developed in future.

### INDUSTRIAL APPLICABILITY

In accordance with the swing control apparatus and method for a construction machine of the present invention as constructed above, the boom-up or swing priority function is implemented depending on the work range by the swing angle during the loading, thereby improving workability and manipulability, and increasing the fuel efficiency.

While the present invention has been described in connection with the specific embodiments illustrated in the drawings, they are merely illustrative, and the invention is not limited to these embodiments. It is to be understood that various equivalent modifications and variations of the embodiments can be made by a person having an ordinary skill in the art without departing from the spirit and scope of the present invention. Therefore, the true technical scope of the present invention should not be defined by the above-mentioned embodiments but should be defined by the appended claims and equivalents thereof.

1. A swing control method for a construction machine including a hydraulic pump 10, a swing motor 11 and a boom cylinder 12 connected in parallel to the hydraulic pump 10, a swing electro-hydraulic valve 13 installed in a flow path between the hydraulic pump 10 and the swing motor 11, a boom electro-hydraulic valve 14 installed in a flow path between the hydraulic pump 10 and the boom cylinder 12, a swing joystick 15 and a boom joystick 16, and a controller 17, the swing control method comprising:
a first step (S100) of selecting a boom-up priority function or a swing priority function through an external input device;
a second step (S200) of determining whether to perform a combined operation of boom-up and swing based on a manipulation signal applied to the controller 17 in response to a manipulation of the boom joystick 16 and the swing joystick 15; and
a third step (S300) of relatively limiting the flow rate of hydraulic fluid supplied from the hydraulic pump 10 to the swing motor 11 by variably controlling the amount of opening of the swing electro-hydraulic valve 13 if a boom-up priority function is selected and the combined operation is set to be performed, and relatively limiting the flow rate of hydraulic fluid supplied from the hydraulic pump 10 to the boom cylinder 12 by variably controlling the amount of opening of the boom electro-hydraulic valve 14 if a swing priority function is selected and the combined operation is set to be performed.

2. The swing control method according to claim 1, wherein the external input device in the first step (S100) comprises a work range select switch 18 which outputs a manipulation signal according to the manipulation of the swing joystick or the boom joystick to the controller 17 so that the controller 17 can control the amount of opening of the boom or swing electro-hydraulic valve 13 or 14 to correspond to a swing angle selected by a user after a work range by the swing angle is preset and stored in the controller 17 by the user.

3. The swing control method according to claim 2, wherein if a first switch unit of the work range select switch 18 is selected, the controller 17 recognizes the work range as a work range at which the swing angle is relatively small and controls the amount of opening of the boom or swing electro-hydraulic valve 13 or 14 to correspond to the relatively small swing angle preset and stored in the controller 17,
wherein if a second switch unit of the work range select switch 18 is selected, the controller 17 recognizes the work range as a work range at which the swing angle is relatively intermediate and controls the amount of opening of the boom or swing electro-hydraulic valve 13 or 14 to correspond to the relatively intermediate swing angle preset and stored in the controller 17, and
wherein if a third switch unit of the work range select switch 18 is selected, the controller 17 recognizes the work range as a work range at which the swing angle is relatively large and controls the amount of opening of the boom or swing electro-hydraulic valve 13 or 14 to correspond to the relatively large swing angle preset and stored in the controller 17.

4. The swing control method according to claim 1, wherein the swing electro-hydraulic valve 13 and the boom electro-hydraulic valve 14 comprise first and second variable orifices 20;21 and 20a;21a installed in meter-in paths 19 and 19a and third and fourth variable orifices 23;24 and 23a;24a installed in meter-out paths 22 and 22a, respectively, so as to variably control the amount of opening of the swing electro-hydraulic valve 13 and the boom electro-hydraulic valve 14 in proportion to the control signal applied thereto from the controller 17.

5. The swing control method according to claim 1, wherein the external input device in the first step (S100) comprises an on/off select switch for allowing a user to select the boom-up priority function or the swing priority function,
wherein if a boom-up priority function select switch is operated to be turned on and a swing priority function select switch is operated to be turned off, the boom-up priority function is determined to be selected, and
wherein if a swing priority function select switch is operated to be turned on and the boom-up priority function select switch is operated to be turned off, the swing priority function is determined to be selected.

6. The swing control method according to claim 5, wherein if the boom-up priority function select switch and the swing priority function select switch are operated to be turned off, the amounts of opening of the boom electro-hydraulic valve 14 and the swing electro-hydraulic valve 13 are controlled in proportion to the manipulation signals by the manipulation of the boom joystick 16 or the swing joystick 15.

7. The swing control method according to claim 1, wherein if a signal indicating the combined operation by the manipulations of the boom joystick 16 and the swing joystick 15 is not applied to the controller 17, the amounts of opening of the boom electro-hydraulic valve 14 and the swing electro-hydraulic valve 13 are controlled in proportion to the manipulation signal by the manipulation of the boom joystick 16 and the swing joystick 15.

8. The swing control method according to claim 1, wherein the external input device in the first step (S100) comprises an imaging means for capturing an image of a work range by the swing angle at a work spot and transmitting an image signal indicating the captured image to the controller 17,
wherein if the work range by the swing angle, of which the image is captured by the imaging means, is larger than a work range by the swing angle, which is pre-stored in the controller 17, the swing priority function is determined to be selected, and
wherein if the work range by the swing angle, of which the image is captured by the imaging means, is smaller than the work range by the swing angle, which is pre-stored in the controller 17, the boom-up priority function is determined to be selected.

9. A swing control apparatus for a construction machine, comprising:
a hydraulic pump 10 connected to an engine;
a swing motor 11 and a boom cylinder 12, which are connected in parallel to the hydraulic pump 10;
a swing electro-hydraulic valve 13 which is installed in a flow path between the hydraulic pump 10 and the swing motor 11 and of which the amount of opening is variably controlled by a control signal applied thereto from an outside;
a boom electro-hydraulic valve 14 which is installed in a flow path between the hydraulic pump 10 and the boom cylinder 12 and of which the amount of opening is variably controlled by a control signal applied thereto from the outside;
a swing joystick 15 configured to output a manipulation signal for controlling the swing motor 11;
a boom joystick 16 configured to output a manipulation signal for controlling the boom cylinder 12;
an external input device configured to select a boom-up priority function or a swing priority function; and
a controller 17 configured to relatively limit the flow rate of hydraulic fluid supplied from the hydraulic pump 10 to the swing motor 11 by variably controlling the amount of opening of the swing electro-hydraulic valve 13 if the boom-up priority function is selected by a manipulation of the external input device and a combined operation of boom-up and swing is set to be performed by the manipulations of the swing joystick 15 and the boom joystick 16, and relatively limit the flow rate of hydraulic fluid supplied from the hydraulic pump 10 to the boom cylinder 12 by variably controlling the amount of opening of the boom electro-hydraulic valve 14 if the swing priority function is selected by a manipulation of the external input device and the combined operation is set to be performed by the manipulations of the swing joystick 15 and the boom joystick 16.

10. The swing control apparatus according to claim 9, wherein the external input device comprises an imaging device for capturing an image of a work range by the swing angle at a work spot and transmitting an image signal indicating the captured image to the controller 17, and
wherein if the work range by the swing angle, of which the image is captured by the imaging device, is larger than a work range by the swing angle, which is pre-stored in the controller 17, the swing priority function is determined to be selected, and
wherein if the work range by the swing angle, of which the image is captured by the imaging device, is smaller than the work range by the swing angle, which is pre-stored in the controller 17, the boom-up priority function is determined to be selected.
